(19) United States
(12) Patent Application Publication
(10) Pub. No.: US 2024/0032565 A1
(43) Pub. Date: Feb. 1, 2024

(54) PLANT-BASED SEAFOOD PRODUCT AND METHODS OF MAKING THE SAME

(71) Applicant: NISHIMOTO CO., LTD., Tokyo (JP)

(72) Inventor: Fumitoshi MURAKAMI, Tokyo (JP)

(21) Appl. No.: 18/360,395

(22) Filed: Jul. 27, 2023

Related U.S. Application Data
(60) Provisional application No. 63/369,876, filed on Jul. 29, 2022.

(51) Int. Cl. A23J 3/22; A23L 19/00; A23L 29/30

(52) U.S. Cl. CPC A23J 3/227; A23L 19/00; A23L 29/30

(57) ABSTRACT

Embodiments described herein are related to a plant-based food product that can be used as an alternative to seafood, such as salmon, tuna, squid, yellowtail, sea bream, shrimp, crab, and scallops. The plant-based seafood products can have a similar texture and flavor as seafood but contain no seafood meat. In some embodiments, the plant-based food product is a vegetarian product.

### CROSS-REFERENCE TO RELATED APPLICATION

This application claims the benefit of U.S. Provisional application No. 63/369,876, filed Jul. 29, 2022, which is incorporated herein in its entirety by reference thereto.

### BACKGROUND

The present disclosure relates to a plant-based food product and methods of making the same. More specifically, the present disclosure relates to a plant-based seafood product that can be an alternative to salmon, tuna, squid, yellowtail, sea bream, shrimp, crab, and scallops.

### BRIEF SUMMARY

Some embodiments are directed to a plant-based food product. In some embodiments, the plant-based food product includes glucomannan; soybean; flour, and starch.

In some embodiments, the glucomannan is present in an amount of less than 2.0 wt %. In some embodiments, the glucomannan is present in an amount from about 0.79 wt % to about 2.0 wt %.

In some embodiments, the flour comprises at least one of rice flour, wheat flour, or cereal flour.

In some embodiments, the starch comprises a processed starch.

In some embodiments, the plant-based food product is gluten-free.

In some embodiments, the plant-based food product comprises at least one of a salmon-alternative, a tuna-alternative, a squid-alternative, a yellowtail-alternative, a sea bream-alternative, a shrimp-alternative, a crab-alternative, or a scallop-alternative.

In some embodiments, the soybean comprises soybean powder or soybean paste.

Some embodiments are directed to a plant-based food product. In some embodiments, the plant-based food product includes glucomannan; soybean; flour; starch; and an oil.

In some embodiments, the glucomannan is present in an amount from about 0.79 wt % to about 2.0 wt %.

In some embodiments, the flour comprises at least one of rice flour, wheat flour, or starch flour.

In some embodiments, the oil is a plant oil. In some embodiments, the plant oil comprises linseed oil.

In some embodiments, the soybean comprises soybean powder or soybean paste.

Some embodiments are directed to a plant-based food product. In some embodiments, the plant-based food product is glucomannan; soybean; flour; starch; an oil; and a sugar.

In some embodiments, the flour comprises at least one of rice flour, wheat flour, or starch flour.

In some embodiments, the oil comprises at least one of linseed oil or amani oil.

In some embodiments, the plant-based food product includes a kelp extract.

In some embodiments, the soybean comprises soybean powder or soybean paste.

In some embodiments, the sugar is trehalose.

### BRIEF DESCRIPTION OF THE FIGURES

FIG. 1 illustrates a plant-based food product according to some embodiments.

FIG. 2 illustrates a plant-based food product according to some embodiments.

FIG. 3 illustrates a plant-based food product according to some embodiments.

FIG. 4 illustrates a plant-based food product according to some embodiments.

FIG. 5 illustrates a plant-based food product according to some embodiments.

FIG. 6 illustrates a plant-based food product according to some embodiments.

FIG. 7 illustrates a plant-based food product according to some embodiments.

FIG. 8 illustrates a plant-based food product according to some embodiments.

FIG. 9 illustrates a method of making a plant-based seafood product according to some embodiments.

### DETAILED DESCRIPTION

Plant-based food products can be a cheaper and more environmentally friendly alternative to animal-based food products. Some embodiments are directed to a plant-based food product that can be used as an alternative to seafood products. In some embodiments, the texture, flavor, and appearance of the plant-based food product is substantially similar to real seafood. In some embodiments, the plant-based food product is prepared in the same way that real seafood is prepared.

Seafood, such as salmon, tuna, squid, yellowtail, sea bream, shrimp, crab, and scallops, are very popular in cuisines around the world. Such seafood is often used for sushi and consumed raw. The seafood are typically caught by commercial fishing businesses. However, the popularity of such seafood can result in over-fishing, which can in turn harm ecosystems and natural resources. Moreover, fishing can be expensive and time-consuming. When used in sushi, the seafood is often eaten fresh as nigiri sushi. This can be challenging for areas that are remote from waters where this seafood is often found.

Accordingly, there is a need for an alternative to seafood, such as salmon, tuna, yellowtail, sea bream, shrimp, crab, or scallops, that has the texture and flavor of raw seafood. Existing seafood alternatives include larger amounts of glucomannan (e.g., about 2.5 wt % to about 4 wt %). However, the taste, texture, and appearance of these existing seafood alternatives can be artificial when compared to actual seafood. For example, the higher glucomannan content of these existing seafood alternatives can create a texture that resembles konjac (e.g., thickener) rather than real seafood. These existing seafood alternatives often use one or more fish-origin seasonings to achieve the desired fishy taste of real seafood. However, existing seafood alternatives that use fish-origin seasonings are not plant-based and are not suitable for vegetarians. The fish-origin seasonings can also be an allergen. These existing seafood alternatives can be difficult to position on sushi rice, making them unsuitable for various applications, such as sushi.

To overcome these shortcomings, embodiments disclosed herein relate to plant-based food products that can be used as an alternative to seafood, such as salmon, tuna, squid, yellowtail, sea bream, shrimp, crab, and scallops. This can help protect natural resources and allow for less expensive sushi in geographic regions that are remote from waters that contain seafood such as salmon, tuna, squid, yellowtail, sea bream, shrimp, crab, or scallops. The disclosed plant-based food products do not include fish-origin seasonings. Accordingly, disclosed embodiments can provide substantially the same taste, texture, and appearance as real seafood but with fewer and simpler ingredients. Moreover, disclosed embodiments can improve adhesiveness, making the product easier to bind with rice when making sushi compared to existing seafood alternatives. The disclosed plant-based food products are also suitable for vegetarians to consume.

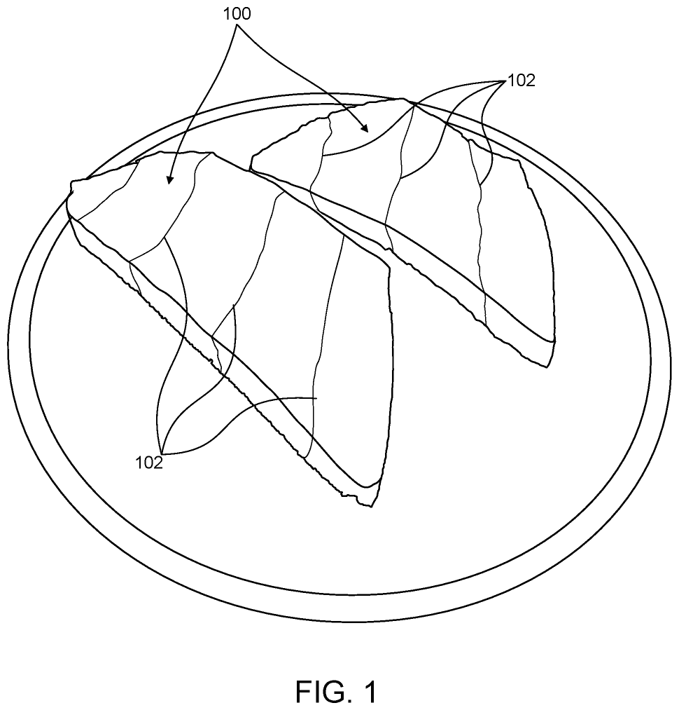

FIG. 1 illustrates plant-based food product 100. In some embodiments, plant-based food product 100 is a tuna-alternative. As used herein, a “tuna-alternative” is a plant-based food product that has the appearance, taste, and texture of tuna. In some embodiments, plant-based food product 100 includes water, sugar (e.g., trehalose), soybean (e.g., soybean powder), flour (e.g., rice flour), starch, kelp extract, oil (e.g., linseed oil), salt, and glucomannan. In some embodiments, plant based food product 100 includes about 75 wt % to about 85 wt % water (e.g., about 83 wt % water). In some embodiments, plant-based food product 100 includes about 4 wt % to about 8 wt % sugar (e.g., about 6 wt % sugar). In some embodiments, plant-based food product 100 includes about 0.5 wt % to about 2 wt % soybean (e.g., about 1 wt % soybean). In some embodiments, plant-based food product 100 includes about 1 wt % to about 3 wt % flour (e.g., about 2 wt % flour). In some embodiments, plant-based food product 100 includes about 2 wt % to about 4 wt % starch (e.g., about 3 wt % starch). In some embodiments, plant-based food product 100 includes about 0.5 wt % to about 2 wt % kelp extract (e.g., about 1 wt % kelp extract). In some embodiments, plant-based food product 100 includes about 1 wt % to about 3 wt % oil (e.g., about 2 wt % oil). In some embodiments, plant-based food product 100 includes about 0.5 wt % to about 2 wt % salt (e.g., about 1 wt % salt). In some embodiments, plant-based food product 100 includes less than about 2 wt % glucomannan (e.g., about 1 wt % glucomannan).

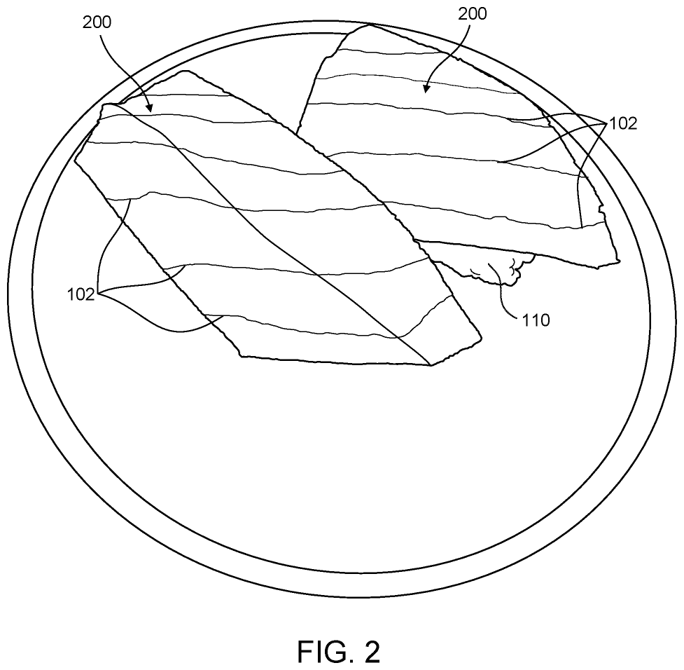

FIG. 2 illustrates plant-based food product 200. In some embodiments, plant-based food product 200 is a salmon-alternative. As used herein, a “salmon-alternative” is a plant-based food product that has the appearance, taste, and texture of salmon. In some embodiments, plant-based food product 200 includes water, sugar (e.g., trehalose), soybean (e.g., soybean powder), flour (e.g., rice flour), starch, kelp extract, oil (e.g., linseed oil), salt, and glucomannan. In some embodiments, plant based food product 200 includes about 75 wt % to about 85 wt % water (e.g., about 82 wt % water). In some embodiments, plant-based food product 200 includes about 4 wt % to about 8 wt % sugar (e.g., about 6 wt % sugar). In some embodiments, plant-based food product 200 includes about 0.5 wt % to about 2 wt % soybean (e.g., about 1 wt % soybean). In some embodiments, plant-based food product 200 includes about 1 wt % to about 3 wt % flour (e.g., about 2 wt % flour). In some embodiments, plant-based food product 200 includes about 2 wt % to about 6 wt % starch (e.g., about 4 wt % starch). In some embodiments, plant-based food product 200 includes about 0.5 wt % to about 2 wt % kelp extract (e.g., about 1 wt % kelp extract). In some embodiments, plant-based food product 200 includes about 1 wt % to about 3 wt % oil (e.g., about 2 wt % oil). In some embodiments, plant-based food product 200 includes about 0.5 wt % to about 2 wt % salt (e.g., about 1 wt % salt). In some embodiments, plant-based food product 200 includes less than about 2 wt % glucomannan (e.g., about 1 wt % glucomannan).

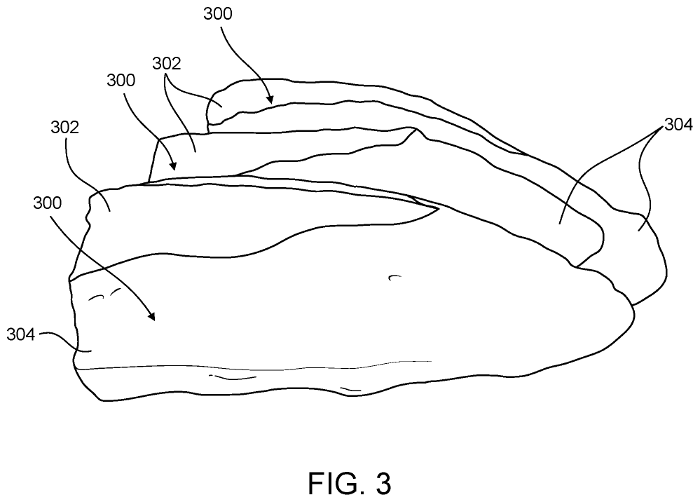

FIG. 3 illustrates plant-based food product 300. In some embodiments, plant-based food product 300 is a yellowtail-alternative. As used herein, a “yellowtail-alternative” is a plant-based food product that has the appearance, taste, and texture of yellowtail. In some embodiments, as shown in FIG. 3, plant-based food product 300 can have two sections 302 and 304. In some embodiments, upper section 302 is a different color than lower section 304. In some embodiments, plant-based food product 300 includes water, sugar (e.g., trehalose), soybean (e.g., soybean powder), flour (e.g., rice flour), starch, kelp extract, oil (e.g., linseed oil), salt, and glucomannan. In some embodiments, plant based food product 300 includes about 75 wt % to about 85 wt % water (e.g., about 81 wt % water). In some embodiments, plant-based food product 300 includes about 3 wt % to about 7 wt % sugar (e.g., about 5 wt % sugar). In some embodiments, plant-based food product 300 includes about 1 wt % to about 3 wt % soybean (e.g., about 2 wt % soybean). In some embodiments, plant-based food product 300 includes about 1 wt % to about 3 wt % flour (e.g., about 2 wt % flour). In some embodiments, plant-based food product 300 includes about 2 wt % to about 4 wt % starch (e.g., about 3 wt % starch). In some embodiments, plant-based food product 300 includes less than about 1 wt % kelp extract. In some embodiments, plant based food product includes no kelp extract. In some embodiments, plant-based food product 300 includes about 1 wt % to about 3 wt % oil (e.g., about 2 wt % oil). In some embodiments, plant-based food product 300 includes about 0.5 wt % to about 2 wt % salt (e.g., about 1 wt % salt). In some embodiments, plant-based food product 300 includes less than about 2 wt % glucomannan (e.g., about 1 wt % glucomannan).

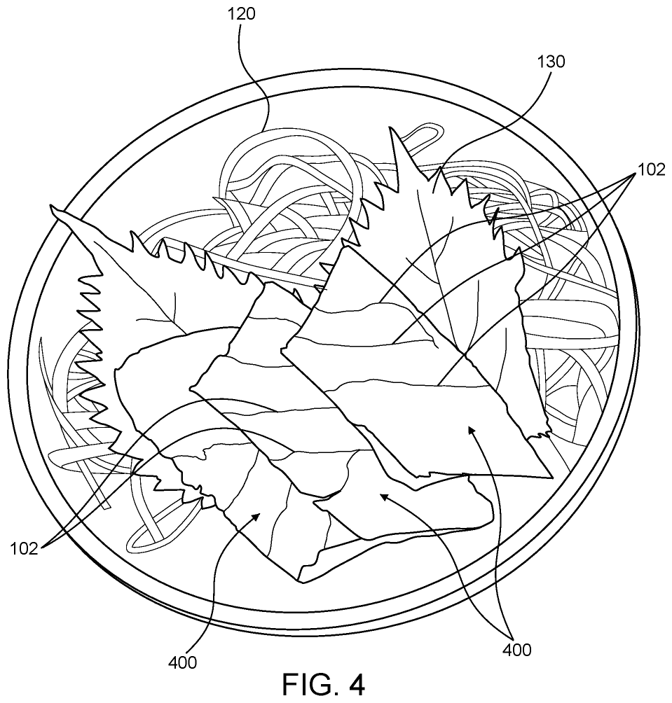

FIG. 4 illustrates plant-based food product 400. In some embodiments, plant-based food product 400 is a sea bream-alternative. As used herein, a “sea bream-alternative” is a plant-based food product that has the appearance, taste, and texture of sea bream. In some embodiments, plant-based food product 400 includes water, sugar (e.g., trehalose), soybean (e.g., soybean powder), flour (e.g., rice flour), starch, kelp extract, oil (e.g., linseed oil), salt, and glucomannan. In some embodiments, plant based food product 400 includes about 75 wt % to about 85 wt % water (e.g., about 81 wt % water). In some embodiments, plant-based food product 400 includes about 3 wt % to about 7 wt % sugar (e.g., about 5 wt % sugar). In some embodiments, plant-based food product 400 includes about 1 wt % to about 3 wt % soybean (e.g., about 2 wt % soybean). In some embodiments, plant-based food product 400 includes about 1 wt % to about 3 wt % flour (e.g., about 2 wt % flour). In some embodiments, plant-based food product 400 includes about 2 wt % to about 4 wt % starch (e.g., about 3 wt % starch). In some embodiments, plant-based food product 400 includes less than about 1 wt % kelp extract. In some embodiments, plant based food product includes no kelp extract. In some embodiments, plant-based food product 400 includes about 1 wt % to about 3 wt % oil (e.g., about 2 wt % oil). In some embodiments, plant-based food product 400 includes about 0.5 wt % to about 2 wt % salt (e.g., about 1 wt % salt). In some embodiments, plant-based food product 400 includes less than about 2 wt % glucomannan (e.g., about 1 wt % glucomannan).

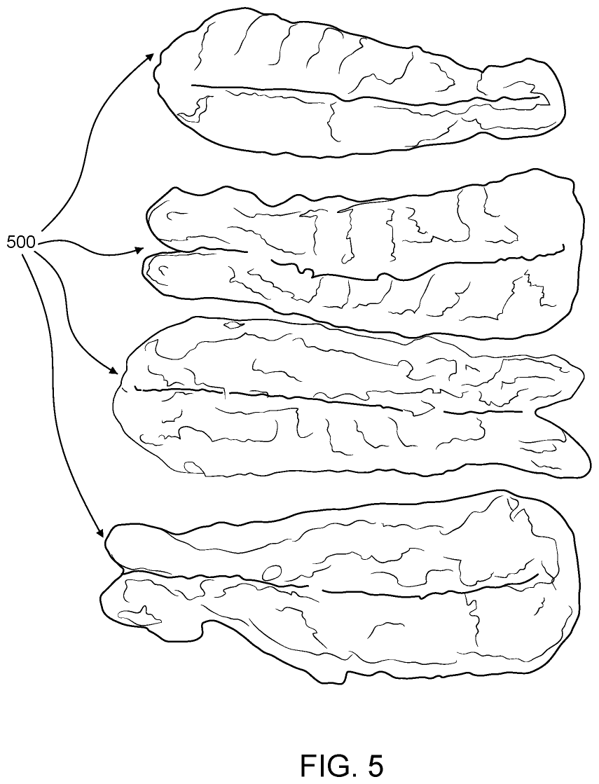

FIG. 5 illustrates plant-based food product 500. In some embodiments, plant-based food product 500 is a shrimp-alternative. As used herein, a “shrimp-alternative” is a plant-based food product that has the appearance, taste, and texture of shrimp. In some embodiments, plant-based food product 500 includes water, sugar (e.g., trehalose), soybean (e.g., soybean powder), flour (e.g., rice flour), starch, kelp extract, oil (e.g., linseed oil), salt, and glucomannan. In some embodiments, plant based food product 500 includes about 75 wt % to about 85 wt % water (e.g., about 82 wt % water). In some embodiments, plant-based food product 500 includes about 2 wt % to about 6 wt % sugar (e.g., about 4 wt % sugar). In some embodiments, plant-based food product 500 includes about 0.5 wt % to about 2 wt % soybean (e.g., about 1 wt % soybean). In some embodiments, plant-based food product 500 includes about 0.5 wt % to about 2 wt % flour (e.g., about 1 wt % flour). In some embodiments, plant-based food product 500 includes about 2 wt % to about 6 wt % starch (e.g., about 4 wt % starch). In some embodiments, plant-based food product 500 includes less than about 1 wt % kelp extract. In some embodiments, plant based food product includes no kelp extract. In some embodiments, plant-based food product 500 includes about 0.5 wt % to about 2 wt % oil (e.g., about 1 wt % oil). In some embodiments, plant-based food product 500 includes about 1 wt % to about 3 wt % salt (e.g., about 2 wt % salt). In some embodiments, plant-based food product 500 includes less than about 2 wt % glucomannan (e.g., about 1 wt % glucomannan).

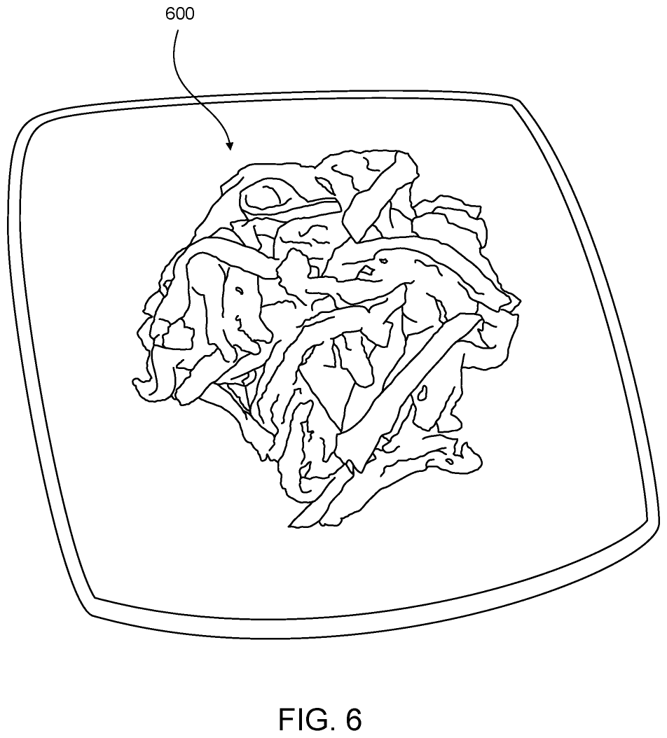

FIG. 6 illustrates plant-based food product 600. In some embodiments, plant-based food product 600 is a crab alternative. As used herein, a “crab-alternative” is a plant-based food product that has the appearance, taste, and texture of crab. In some embodiments, plant-based food product 600 includes water, sugar (e.g., trehalose), soybean (e.g., soybean powder), flour (e.g., rice flour), starch, kelp extract, oil (e.g., linseed oil), salt, and glucomannan. In some embodiments, plant based food product 600 includes about 75 wt % to about 85 wt % water (e.g., about 83 wt % water). In some embodiments, plant-based food product 600 includes about 2 wt % to about 6 wt % sugar (e.g., about 4 wt % sugar). In some embodiments, plant-based food product 600 includes less than about 1 wt % soybean. In some embodiments, plant based food product includes soybean. In some embodiments, plant-based food product 600 includes about 0.5 wt % to about 2 wt % flour (e.g., about 1 wt % flour). In some embodiments, plant-based food product 600 includes about 2 wt % to about 6 wt % starch (e.g., about 4 wt % starch). In some embodiments, plant-based food product 600 includes less than about 1 wt % kelp extract. In some embodiments, plant based food product includes no kelp extract. In some embodiments, plant-based food product 600 includes about 1 wt % to about 3 wt % oil (e.g., about 2 wt % oil). In some embodiments, plant-based food product 600 includes about 1 wt % to about 3 wt % salt (e.g., about 2 wt % salt). In some embodiments, plant-based food product 600 includes less than about 2 wt % glucomannan (e.g., about 1 wt % glucomannan).

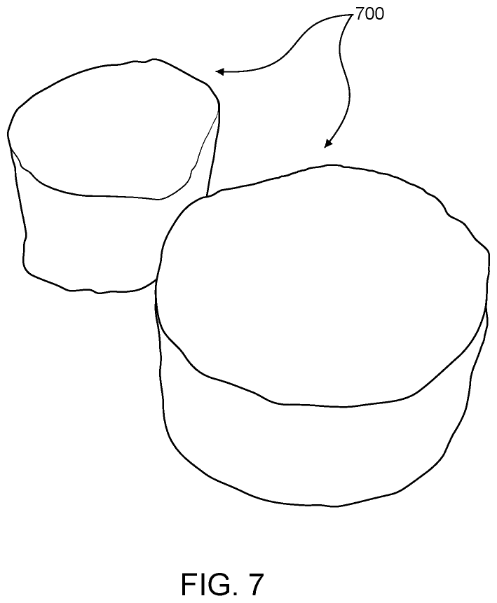

FIG. 7 illustrates plant-based food product 700. In some embodiments, plant-based food product 700 is a scallop alternative. As used herein, a “scallop-alternative” is a plant-based food product that has the appearance, taste, and texture of scallop. In some embodiments, plant-based food product 700 includes water, sugar (e.g., trehalose), soybean (e.g., soybean powder), flour (e.g., rice flour), starch, kelp extract, oil (e.g., linseed oil), salt, and glucomannan. In some embodiments, plant based food product 700 includes about 75 wt % to about 85 wt % water (e.g., about 79 wt % water). In some embodiments, plant-based food product 700 includes about 4 wt % to about 8 wt % sugar (e.g., about 6 wt % sugar). In some embodiments, plant-based food product 700 includes about 2 wt % to about 6 wt % soybean (e.g., about 4 wt % soybean). In some embodiments, plant-based food product 700 includes about 2 wt % to about 6 wt % flour (e.g., about 4 wt % flour). In some embodiments, plant-based food product 700 includes about 2 wt % to about 6 wt % starch (e.g., about 4 wt % starch). In some embodiments, plant-based food product 700 includes about 0.5 wt % to about 2 wt % kelp extract (e.g., about 1 wt % kelp extract). In some embodiments, plant-based food product 700 includes about 0.5 wt % to about 2 wt % oil (e.g., about 1 wt % oil). In some embodiments, plant-based food product 700 includes less than about 1 wt % salt. In some embodiments, plant based food product includes no salt. In some embodiments, plant-based food product 700 includes less than about 2 wt % glucomannan (e.g., about 1 wt % glucomannan).

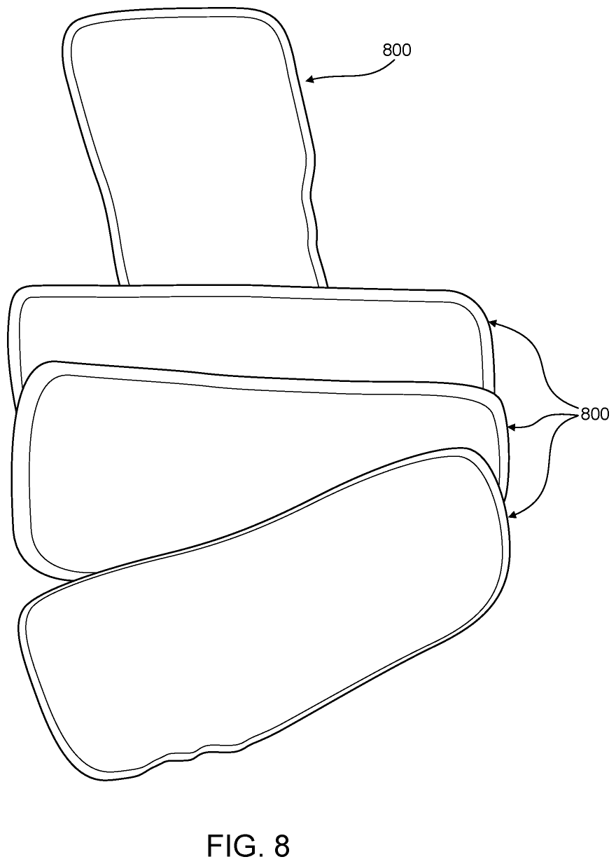

FIG. 8 illustrates plant-based food product 800. In some embodiments, plant-based food 800 is a squid alternative. As used herein, a “squid-alternative” is a plant-based food product that has the appearance, taste, and texture of squid. In some embodiments, plant-based food 800 includes water, sugar (e.g., trehalose), soybean (e.g., soybean powder), flour (e.g., rice flour), starch, kelp extract, oil (e.g., linseed oil), salt, and glucomannan. In some embodiments, plant based food product 800 includes about 75 wt % to about 85 wt % water (e.g., about 81 wt % water). In some embodiments, plant-based food 800 includes about 2 wt % to about 6 wt % sugar (e.g., about 4 wt % sugar). In some embodiments, plant-based food product 800 includes less than about 1 wt % soybean. In some embodiments, plant based food product includes soybean. In some embodiments, plant-based food 800 includes about 0.5 wt % to about 2 wt % flour (e.g., about 1 wt % flour). In some embodiments, plant-based food 800 includes about 2 wt % to about 6 wt % starch (e.g., about 4 wt % starch). In some embodiments, plant-based food product 800 includes about 0.5 wt % to about 2 wt % kelp extract (e.g., about 1 wt % kelp extract). In some embodiments, plant-based food product 800 includes about 1 wt % to about 3 wt % oil (e.g., about 2 wt % oil). In some embodiments, plant-based food 800 includes 1 wt % to about 3 wt % salt (e.g., about 2 wt % salt). In some embodiments, plant-based food product 800 includes less than about 2 wt % glucomannan (e.g., about 1 wt % glucomannan).

In some embodiments, the plant-based food product (e.g., products 100, 200, 300, 400, 500, 600, 700, or 800) can be served with rice 110, shredded radish 120, and/or shiso leaves 130. In some embodiments, rice 110 is a sushi rice.

In some embodiments, the plant-based food product (e.g., products 100, 200, 300, 400, 500, 600, 700, or 800) has a texture and flavor similar to raw seafood. In some embodiments, the texture and flavor is achieved by adding one or more of okara (bean curd), rice flour, and/or starch to glucomannan.

In some embodiments, a flour can be added to glucomannan to achieve the texture and flavor of actual seafood. In some embodiments, the flour can include rice flour, wheat flour, cereal flour, or combinations thereof. In some embodiments, the cereal flour can be made from corn, buckwheat, millet, chaff, or combinations thereof. In some embodiments, the flour is rice flour. In some embodiments, the flour is added in a range from greater than 0 wt % to less than about 5 wt % of the total weight of the plant-based food product. In some embodiments, the flour is added in a range from about 0.5 wt % to about 5 wt %, from about 1 wt % to about 4.5 wt %, from about 2 wt % to about 4 wt %, from about 2.5 wt % to about 3.5 wt %, or within a range having any two of these values as endpoints. In some embodiments, the flour is present in an amount of about 1 wt %. In some embodiments, the flour is present in an amount of about 2 wt %. In some embodiments, the flour is present in an amount of about 4 wt %.

In some embodiments, a starch can be added to glucomannan. In some embodiments, the starch is a processed starch (e.g., tapioca starch). In some embodiments, processed starches can be used due to their freeze-resistance properties. In some embodiments, the starch is added in a range from greater than about 1 wt % to less than about 6 wt %. In some embodiments, the starch is added in a range about 1 wt % to about 6 wt %, from about 2 wt % to about 5 wt %, from about 3 wt % to about 4 wt %, or within a range having any two of these values as endpoints. In some embodiments, the starch is present in an amount of about 3 wt %. In some embodiments, the starch is present in an amount of about 4 wt %.

In some embodiments, glucomannan is present in an amount less than about 2% of the total weight of the plant-based food product. In some embodiments, glucomannan is added in a range from about 0.25 wt % to about 2.0 wt %, from about 0.5 wt % to about 1.5 wt %, from about 0.75 wt % to about 1.0 wt %, from about 0.79 wt % to about 2.0 wt %, or within a range having any two of these values as endpoints. In some embodiments, the glucomannan is present in an amount from about 0.79 wt % to about 2 wt %. In some embodiments, the glucomannan is present in an amount of about 1 wt %. In some embodiments, the glucomannan can help achieve the texture and adhesiveness of actual seafood.

In some embodiments, the plant-based food product comprises a kelp extract. As used herein, a kelp extract is a liquid that is extracted from kelp (e.g., seaweed) by boiling kelp. In some embodiments, the kelp extract is added in a range from greater than or equal to about 0 wt % to less than about 3 wt % of the total weight of the plant-based food product. In some embodiments, the kelp extract is added in a range from about 0 wt % to about 3 wt %, from about 0.5 wt % to about 2.5 wt %, from about 1 wt % to about 2 wt %, from about 1.5 wt % to about 1.75 wt %, or within a range having any two of these values as endpoints. In some embodiments, the kelp extract is present in an amount of about 0 wt % (i.e., the plant-based food product contains no kelp extract). In some embodiments, the kelp extract is present in an amount of about 1 wt %.

In some embodiments, the plant-based food product comprises salt. In some embodiments, the salt is a sea salt. In some embodiments, the salt is added in a range from greater than or equal to about 0% to less than about 4% of the total weight of the plant-based food product. In some embodiments, the salt is added in a range from about 0 wt % to about 4 wt %, from about 0.5 wt % to about 3 wt %, from about 1 wt % to about 2.5 wt %, from about 1.5 wt % to about 2 wt %, or within a range having any two of these values as endpoints. In some embodiments, the salt is present in an amount of about 0 wt % (i.e., the plant-based food product contains no salt). In some embodiments, the salt is present in an amount of about 1 wt %. In some embodiments, the salt is present in an amount of about 2 wt %.

In some embodiments, the flavor of the plant-based food product may have a sea flavor by using 100% kelp extract (e.g., kelp extract with no additional substances) and sea salt. In some embodiments, the kelp extract and/or sea salt produces a sea flavor and umami flavor. In some embodiments, a combination of natural sea salt, glutamic acid, and/or alginic acid can be used in the plant-based food product to bring out a subtle sea flavor for use in nigiri sushi. In some embodiments, the plant-based food product can include okara (e.g., soybean paste), bean curd, rice flour, starch, glucomannan, linseed oil, omega-3, dietary fiber, Euglena, kelp extract, natural sea salt, or combinations thereof.

In some embodiments, the soybean is added in a range from greater than or equal to about 0 wt % to less than about 6 wt %. In some embodiments, the soybean is added in a range about 0 wt % to about 6 wt %, from about 1 wt % to about 5 wt %, from about 2 wt % to about 4 wt %, or within a range having any two of these values as endpoints. In some embodiments, the soybean is present in an amount of about 0 wt % (i.e., the plant-based food product contains no soybean). In some embodiments, the soybean is present in an amount of about 1 wt %. In some embodiments, the soybean is present in an amount of about 2 wt %. In some embodiments, the soybean is present in an amount of about 4 wt %. In some embodiments, the plant-based food product comprises an oil. In some embodiments, the oil is a plant-based oil (e.g., linseed oil). In some embodiments, the oil is linseed oil. In some embodiments, the oil (e.g., linseed oil) can be used to produce a sea flavor. In some embodiments, the oil is added in a range from greater than about 0.5 wt % to less than about 3 wt %. In some embodiments, the oil is added in a range about 0.5 wt % to about 3 wt %, from about 1 wt % to about 2.5 wt %, from about 1.5 wt % to about 2 wt %, or within a range having any two of these values as endpoints. In some embodiments, the oil is present in an amount of about 1 wt %. In some embodiments, the oil is present in an amount of about 2 wt %. In some embodiments, the plant-based food product comprises a sugar. In some embodiments, the sugar is trehalose. In some embodiments, the sugar is added in a range from greater than about 2 wt % to less than about 7 wt %. In some embodiments, the sugar is added in a range about 2 wt % to about 7 wt %, from about 3 wt % to about 6 wt %, from about 4 wt % to about 5 wt %, or within a range having any two of these values as endpoints. In some embodiments, the sugar is present in an amount of about 4 wt %. In some embodiments, the sugar is present in an amount of about 5 wt %. In some embodiments, the sugar is present in an amount of about 6 wt %. In some embodiments, plant-based food product comprises water. In some embodiments, the water is added in a range from greater than about 75 wt % to less than about 85 wt %. In some embodiments, the water is added in a range about 75 wt % to about 85 wt %, from about 77 wt % to about 83 wt %, from about 79 wt % to about 82 wt %, from about 80 wt % to about 81 wt %, or within a range having any two of these values as endpoints. In some embodiments, the water is present in an amount of about 79 wt %. In some embodiments, the water is present in an amount of about 81 wt %. In some embodiments, the water is present in an amount of about 82 wt %. In some embodiments, the water is present in an amount of about 83 wt %.

In some embodiments, the texture of the plant-based food product is the sticky texture similar to tuna sashimi. In some embodiments, the texture is the sticky texture of salmon sashimi. In some embodiments, the plant-based food product has an elastic texture, such as sticky or chewy.

As shown in FIGS. 1 and 2, for example, the plant-based food product can have streaks 102 similar to the muscle fibers of real raw salmon and tuna. In some embodiments, streaks 102 are white streaks. In some embodiments, soybean powder is used to achieve an adhesiveness, such that the plant-based food product adheres to rice when making a sushi roll or nigiri roll. In some embodiments, thickeners (e.g., carrageenan or locust bean gum) can be used in the plant-based food product. In some embodiments, the thickeners can be used to solidify the plant-based food product. This can provide an adhesiveness for sticking to sushi rice. In some embodiments, soybean powder is used to achieve a rough texture similar to real raw seafood. In some embodiments, a base paste and white line paste can be layered to achieve the appearance of muscle fibers similar to real raw salmon and tuna.

In some embodiments, the plant-based food product has a luster similar to sashimi. In some embodiments, the luster is achieved by adding an oil (e.g., linseed oil). In some embodiments, the plant-based food product can have a gloss-like appearance.

In some embodiments, the plant-based food product does not contain seafood or animal meat. In some embodiments, the plant-based food product is gluten free. In some embodiments, the plant-based food product is animal free. In some embodiments, the plant-based food product is suitable for consumption by vegetarians and/or vegans.

In some embodiments, the plant-based food product can have various nutritional components, for example, omega-3, linseed oil, dietary fiber, Euglena, and vitamins (e.g., B6 and B12). In some embodiments, the plant-based food product contains from about 1 gram to about 2 grams of protein per 100 grams of plant-based food product. In some embodiments, the plant-based food product contains about 1.1 grams of protein per 100 grams of plant-based food product. In some embodiments, the plant-based food product contains from about 2 grams to about 4 grams of fat per 100 grams of plant-based food product. In some embodiments, the plant-based food product contains from about 2.5 grams of fat per 100 grams of plant-based food product. In some embodiments, the plant-based food product contains about 10 grams to about 15 grams of carbohydrates per 100 grams of plant-based food product. In some embodiments, the plant-based food product contains about 13.4 grams of carbohydrates per 100 grams of plant-based food product. In some embodiments, the plant-based food product contains about 260 milligrams to about 300 milligrams of sodium per 100 grams of plant-based food product. In some embodiments, the plant-based food product contains about 280 milligrams of sodium per 100 grams of plant-based food product. In some embodiments, the plant-based food product contains about 1 gram to about 2 grams of minerals (e.g., ash) per 100 grams of plant-based food product. In some embodiments, the plant-based food product contains about 1.5 grams of minerals per 100 grams of plant-based food product. In some embodiments, the plant-based food product contains about 0.5 grams to about 1 gram of sodium chloride per 100 grams of plant-based food product. In some embodiments, the plant-based food product contains about 0.7 grams of sodium chloride per 100 grams of plant-based food product.

In some embodiments, the plant-based food product offers better sustainability compared to fishing by reducing commercial fishing. This in turn can help protect natural resources.

In some embodiments, the plant-based food product is less expensive on a per unit basis compared to fresh seafood, such as salmon, tuna, squid, yellowtail, sea bream, shrimp, crab, or scallops.

In some embodiments, the plant-based food product has a gloss-like appearance similar to that of seafood, such as salmon, tuna, squid, yellowtail, sea bream, shrimp, crab, or scallops. In some embodiments, the gloss-like appearance of the plant-based food product can be affected by the addition of oil (e.g., linseed oil).

In some embodiments, the plant-based food product can be frozen and later thawed before consumption. In some embodiments, the plant-based food product can be frozen and then defrosted in a microwave. In some embodiments, the plant-based food product can be frozen and then defrosted in boiling water. In some embodiments, the plant-based food product can be frozen and then defrosted in cold water.

In some embodiments, the plant-based food product can be prepared for consumption using methods similar to preparing seafood. For example, the plant-based food product can be ground, shredded, cubed, or sliced, as shown in FIGS. 4 and 6. For example, FIG. 4 shows sliced sea bream-alternative and FIG. 6 shows shredded crab-alternative.

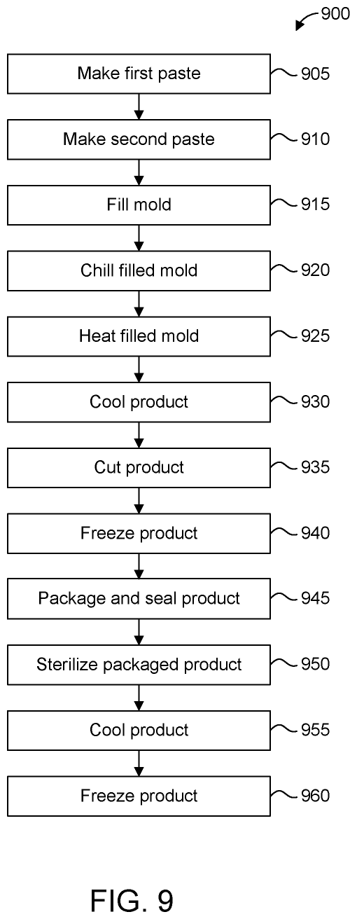

In some embodiments, the plant-based food product can be packaged. In some embodiments, the plant-based food product can be vacuum sealed. The plant-based food product (e.g., products 100, 200, 300, 400, 500, 600, 700, or 800) may be using method 900, illustrated by the flow chart in FIG. 9.

At step 905, a first paste can be made. In some embodiments, the first paste can be a base paste. In some embodiments, the base paste can be made using a vegetable, water, a pigment, seasoning, oil, one or more inorganic compounds, or combinations thereof. In some embodiments, the vegetable includes konjac powder, rice flour, soybean powder, or combinations thereof. In some embodiments, the pigment includes paprika pigment. In some embodiments, the seasoning includes salt. In some embodiments, the oil includes linseed oil. In some embodiments, the inorganic compound is a calcium hydroxide solution. In some embodiments, the first paste is made by combining konjac, water, paprika pigment, salt, linseed oil, and calcium hydroxide solution. In some embodiments, the vegetable (e.g., konjac powder) can be made used as a base. In some embodiments, a mixture of water and the pigment (e.g., paprika pigment) can be formed. In some embodiments, the vegetable base can be added to the mixture and mixed. In some embodiments, after mixing, the oil (e.g., linseed oil or amani oil) can be added to form a second mixture. In some embodiments, after adding the oil, the inorganic compound (e.g., a calcium hydroxide solution) can be added to the second mixture.

At step 910, a second paste can be made. In some embodiments, the second paste can be a white paste. In some embodiments, the second paste can be made using a white paste base and an inorganic compound (e.g., a calcium hydroxide solution). In some embodiments, the white paste base can be made using a glucomannan, water, one or more inorganic compounds, starch, or combinations thereof. In some embodiments, the inorganic compound is calcium carbonate. In some embodiments, the starch includes a processed starch. In some embodiments, the second paste can be made by combining white line base with calcium hydroxide solution.

At step 915, a mold can be filled with the first paste, the second paste, or both. In some embodiments, the mold can be filled by alternating the first paste and the second paste. The first paste and the second paste can be alternated at least 4 times (e.g., at least 6 times, at least 8 times, or at least 10 times). In some embodiments, the first paste and the second paste are alternated 4 times to 10 times. In some embodiments, the second paste is a white paste, and the white paste layers provide the appearance of muscle fibers similar to, for example, tuna and salmon.

At step 920, the filled mold can be chilled. In some embodiments, the filled mold is chilled (e.g., by refrigeration) for at least 4 hours (e.g., at least 6 hours, at least 8 hours, or at least 10 hours). In some embodiments, the filled mold is chilled for from about 4 hours to about 10 hours.

At step 925, after refrigeration, the filled mold can be heated. In some embodiments, the filled mold can be boiled. In some embodiments, the filled mold can be heated to a temperature of about 90° C. to about 100° C. In some embodiments, the filled mold can be heated for about 60 minutes to about 90 minutes. In some embodiments, the filled mold can be heated to a temperature of about 95° C. for about 81 minutes.

At step 930, after heating, the plant-based food product can be removed from the mold and cooled. In some embodiments, the plant-based food product can be cooled in an ice bath. In some embodiments, the plant-based food product can be cooled for from about 40 minutes to about 80 minutes. In some embodiments, the plant-based food product can be cooled for about 60 minutes.

At step 935, after cooling, the plant-based food product can be cut, ground, cubed, or sliced. In some embodiments, the plant-based food product can be cut into filet-sized pieces, as shown in FIGS. 1 and 2. In some embodiments, the plant-based food product can be sliced, as shown in FIGS. 3, 4, and 8. In some embodiments, the plant-based food product can be cut into shrimp-shaped pieces, as shown in FIG. 5. In some embodiments, the plant-based food product can be ground or cut into strips, as shown in FIG. 6. In some embodiments, the plant-based food product can be cut into cylindrical shapes similar to scallops, as shown in FIG. 7. In some embodiments, the plant-based food product can be cut vertically about every 2.5 centimeters.

At step 940, the plant-based food product can be frozen. In some embodiments, the freezing is done using a quick-freeze method. In some embodiments, the plant-based food product can be frozen to a temperature of from about 0° C. to about −50° C. In some embodiments, the plant-based food product can be frozen to a temperature of about −40° C. The plant-based food product can be frozen for from about 30 minutes to about 90 minutes. In some embodiments, the plant-based food product can be frozen for about 61 minutes.

At step 945, the plant-based food product can be packaged and sealed. In some embodiments, the plant-based food product can be vacuum sealed.

At step 950, after packaging, the plant-based food product can be heated to sterilize

the plant-based food product. In some embodiments, the plant-based food product can be heat sterilized at a temperature from about 75° C. to about 120° C. In some embodiments, the plant-based food product can be heat sterilized at a temperature of about 90° C. In some embodiments, the plant-based food product can be heat sterilized for from about 15 minutes to about 30 minutes. In some embodiments, the plant-based food product can be heat sterilized for about 21 minutes.

At step 955, after sterilization, the plant-based food product can be cooled. In some embodiments, the plant-based food product can be cooled in an ice bath. In some embodiments, method of heating, cooling, and heat sterilizing the plant-based food product can contribute to an elastic texture.

At step 960, the plant-based food product can be frozen. In some embodiments, the

freezing is done using a quick-freeze method. In some embodiments, the plant-based food product can be frozen to a temperature of from about 0° C. to about −50° C. In some embodiments, the plant-based food product can be frozen to a temperature of about −40° C. The plant-based food product can be frozen for from about 30 minutes to about 90 minutes. In some embodiments, the plant-based food product can be frozen for about 61 minutes.

### EXAMPLES

### Example 1

In one experiment, a taste test was completed for comparing seafood alternative products to real seafood. Eight evaluators tested each product. Three products were tested: one plant-based food product according to embodiments disclosed herein (Product A) and two existing seafood alternative products (Products B and C). For each product, the appearance, texture, adhesiveness, and taste were evaluated on a scale from 1 to 4 (1: very different characteristics to real seafood; 2: slightly different characteristics to real seafood; 3: similar characteristics to real seafood; and 4: very similar characteristics to real seafood). The table below shows the average values graded by the eight evaluators for each evaluated category.

TABLE 1

| Product | Appearance | Texture | Adhesiveness | Taste |
|---|---|---|---|---|
| A | 3 | 2.3 | 2.6 | 2.1 |
| B | 2.6 | 1.8 | 1.6 | 1.5 |
| C | 2.5 | 1.8 | 1.6 | 1.6 |

As shown in Table 1, the plant-based food product according to embodiments disclosed herein (Product A) showed improved appearance, texture, adhesiveness, and taste compared to existing products (Products B and C).

### Example 2

In one experiment, plant-based food products were made that were alternatives to salmon, tuna, squid, yellowtail, sea bream, shrimp, crab, and scallops. The table below shows the composition by weight percent (wt %) of different components for the different plant-based food products.

TABLE 2

| Components | Salmon | Tuna | Squid | Yellowtail | Sea Bream | Shrimp | Crab | Scallop |
|---|---|---|---|---|---|---|---|---|
| Water | 82% | 83% | 81% | 81% | 81% | 82% | 83% | 79% |
| Trehalose | 6% | 6% | 4% | 5% | 5% | 4% | 4% | 6% |
| Soybean | 1% | 1% | — | 2% | 2% | 1% | — | 4% |
| Powder | | | | | | | | |
| Rice Flour | 2% | 2% | 1% | 2% | 2% | 1% | 1% | 4% |
| Modified | 4% | 3% | 4% | 3% | 3% | 4% | 4% | 4% |
| Starch | | | | | | | | |
| Kelp Extract | 1% | 1% | 1% | — | — | — | — | 1% |
| Linseed Oil | 2% | 2% | 2% | 2% | 2% | 1% | 2% | 1% |
| Salt | 1% | 1% | 2% | 1% | 1% | 2% | 2% | — |
| Glucomannan | 1% | 1% | 1% | 1% | 1% | 1% | 1% | 1% |
| Other | — | — | 4% | 3% | 3% | 4% | 3% | — |
| Ingredients | | | | | | | | |
| Total | 100% | 100% | 100% | 100% | 100% | 100% | 100% | 100% |

The other ingredients shown in Table 2 can include various food additives, such as seasonings and colorings.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A plant-based food product, comprising:
glucomannan;
soybean;
flour; and
starch.

2. The plant-based food product of claim 1, wherein the glucomannan is present in an amount of less than 2.0 wt %.

3. The plant-based food product of claim 1, wherein the glucomannan is present in an amount from about 0.79 wt % to about 2.0 wt %.

4. The plant-based food product of claim 1, wherein the flour comprises at least one of rice flour, wheat flour, or cereal flour.

5. The plant-based food product of claim 1, wherein the starch comprises a processed starch.

6. The plant-based food product of claim 1, wherein the plant-based food product is gluten-free.

7. The plant-based food product of claim 1, wherein the plant-based food product comprises at least one of a salmon-alternative, a tuna-alternative, a squid-alternative, a yellowtail-alternative, a sea bream-alternative, a shrimp-alternative, a crab-alternative, or a scallop-alternative.

8. The plant-based food product of claim 1, wherein the soybean comprises soybean powder or soybean paste.

9. A plant-based food product, comprising:
glucomannan;
soybean;
flour;
starch; and
an oil.

10. The plant-based food product of claim 9, wherein the glucomannan is present in an amount from about 0.79 wt % to about 2.0 wt %.

11. The plant-based food product of claim 9, wherein the flour comprises at least one of rice flour, wheat flour, or starch flour.

12. The plant-based food product of claim 9, wherein the oil is a plant oil.

13. The plant-based food product of claim 12, wherein the plant oil comprises linseed oil.

14. The plant-based food product of claim 9, wherein the soybean comprises soybean powder or soybean paste.

15. A plant-based food product, comprising:
glucomannan;
soybean;
flour;
starch;
an oil; and
a sugar.

16. The plant-based food product of claim 15, wherein the flour comprises at least one of rice flour, wheat flour, or starch flour.

17. The plant-based food product of claim 15, wherein the oil comprises at least one of linseed oil or amani oil.

18. The plant-based food product of claim 15, further comprising a kelp extract.

19. The plant-based food product of claim 15, wherein the soybean comprises soybean powder or soybean paste.

20. The plant-based food product of claim 15, wherein the sugar is trehalose.
